(19) United States
(12) Patent Application Publication
(10) Pub. No.: US 2020/0093580 A1
(43) Pub. Date: Mar. 26, 2020

(54) DENTAL ARTICULATOR CAPABLE OF FIXED HORIZONTAL CONDYLE AND ADJUSTABLE HORIZONTAL CONDYLE

(71) Applicant: TESCO DENTAL (HONG KONG) LIMITED, Lai Chi Kok (HK)

(72) Inventor: Chun Pong CHEUNG, Quarry Bay (HK)

(21) Appl. No.: 16/136,969

(22) Filed: Sep. 20, 2018

(51) Int. Cl. A61C 11/02; A61C 11/06; A61C 11/08

(52) U.S. Cl. CPC A61C 11/022; A61C 11/025; A61C 11/081; A61C 11/06

(57) ABSTRACT

A dental articulator (10) includes a lower base (12) having two support arms (28) extending therefrom. Each support arm (28) includes an upper end with an opening (30) therein. Each opening (30) is adapted to receive a fixed-angle temporomandibular joint assembly (32) having a fixed horizontal condyle angle or an adjustable-angle temporomandibular joint assembly (34) having an adjustable horizontal condyle angle. A dental articulator kit may initially include only a pair of fixed-angle temporomandibular joint assemblies (32) with the pair of adjustable-angle temporomandibular joint assemblies (34) available to be acquired by a user at a later time.

### TECHNICAL FIELD

This invention relates to a dental articulator. The dental articulator may be changed between a fixed horizontal condyle angle and an adjustable horizontal condyle angle.

### BACKGROUND

Articulators are mechanical devices used in dentistry to which casts of the maxillary (upper) and mandibular (lower) teeth may be attached to simulate mandibular movements and reproduce recorded positions of the mandible in relation to the maxilla. Articulators assist in the fabrication of removable prosthodontic appliances (dentures), fixed prosthodontic restorations (crowns, bridges, inlays, and onlays) and orthodontic appliances.

An exemplary articulator is a double cone type articulator, which was originally invented by Albert Gerber. This articulator, and similar subsequently developed non-arcon type articulators, include articulation parts that control the horizontal condyle angle. In certain uses, it may be desirable to utilize a fixed horizontal condyle angle. For other purposes, it may be desirable to utilize an adjustable horizontal condyle angle. There remains a need in the art for an articulator that is adjustable between having a fixed horizontal condyle angle and having an adjustable horizontal condyle angle, such that the user does not need separate articulators for accomplishing each desired feature.

### DISCLOSURE OF THE INVENTION

It is thus an object of the present invention to provide a dental articulator that may be adjustable between having a fixed horizontal condyle angle and having an adjustable horizontal condyle angle.

This and other objects of the present invention, as well as the advantages thereof over existing prior art forms, which will become apparent from the description to follow, are accomplished by the improvements hereinafter described and claimed.

A dental articulator includes a lower base having two support arms extending therefrom. Each support arm has an upper end with an opening therein. Each opening is adapted to receive a fixed-angle temporomandibular joint assembly having a fixed horizontal condyle angle or an adjustable-angle temporomandibular joint assembly having an adjustable horizontal condyle angle.

A dental articulator kit comprising a dental articulator base includes a lower support carrying two support arms extending therefrom. Each support arm has an upper end with an opening therein. The kit includes a pair of fixed-angle temporomandibular joint assemblies having a fixed horizontal condyle angle, and the fixed-angle temporomandibular joint assemblies each have an extension adapted to fit in a respective one of the openings. As an alternative option, the articulator can also be equipped with a pair of adjustable-angle temporomandibular joint assemblies having an adjustable horizontal condyle angle, and the adjustable-angle temporomandibular joint assemblies each having an extension adapted to fit in a respective one of the openings. The optional pair of adjustable-angle temporomandibular joint assemblies may be acquired by a user at a later time such that the user can upgrade the dental articulator kit to include both the pair of fixed temporomandibular joint assemblies and the pair of adjustable temporomandibular joint assemblies, a feature that is not known in the current state of arts. Upon acquiring the pair of adjustable temporomandibular joint assemblies, the fixed-angle temporomandibular joint assemblies and adjustable-angle temporomandibular joint assemblies are interchangeable in the openings based on whether a user of the dental articulator kit desires a fixed horizontal condyle angle or an adjustable horizontal condyle angle.

A method of adjusting a dental articulator includes steps of providing a dental articulator having a lower base with two support arms extending therefrom, each support arm having an upper end with an opening therein, inserting a pair of temporomandibular joint assemblies having a fixed horizontal condyle angle in the openings, removing the pair of temporomandibular joint assemblies having a fixed horizontal condyle angle from the openings, and inserting a pair of temporomandibular joint assemblies having an adjustable horizontal condyle angle in the openings.

A preferred exemplary dental articulator according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a perspective view of a dental articulator according to the concepts of the present invention, having an adjustable-angle temporomandibular joint (TMJ) assembly.

FIG. 2 is a perspective view of the lower base component of the dental articulator.

FIG. 3 is a perspective view of a fixed-angle temporomandibular joint (TMJ) assembly.

FIG. 4 is a side elevational view of a guide member of the TMJ assembly of FIG. 3.

FIG. 5 is an elevational view of the side of the guide member shown in FIG. 4.

FIG. 6 is a perspective view of an adjustable-angle temporomandibular joint (TMJ) assembly.

FIG. 7 is a perspective view of the upper base component of the dental articulator.

FIG. 8 is a bottom plan view of the upper base of FIG. 7.

FIG. 9 is a perspective view of a retrusion lock.

FIG. 10 is a side elevational view showing the retrusion lock in an open position.

FIG. 11 is a side elevational view showing the retrusion lock in a closed position.

FIG. 12 is a perspective view of a TMJ ring.

FIG. 13 is a perspective view of a face bow adapter.

FIG. 14 is a perspective view of the TMJ base member of the adjustable-angle TMJ assembly of FIG. 6.

FIG. 15 is a perspective view of the guide member of the adjustable-angle TMJ assembly of FIG. 6.

FIG. 16 is a side elevational view of the guide member of FIG. 15.

FIG. 17 is a perspective view of an incisal pin assembly.

FIG. 18 is a perspective view of a face bow support.

FIG. 19 is a perspective view of a centric lock.

FIG. 20 is a side elevational view of the centric lock of FIG. 19.

FIG. 21 is a top, partial view showing an O-ring in place in the grooves of an axle and O-ring holders on one side of the dental articulator.

FIG. 22 is a perspective view of a dental articulator according to the concepts of the present invention, having a fixed-angle temporomandibular joint (TMJ) assembly.

FIG. 23 is a perspective, partial view of a TMJ centric lock in a locked position.

### PREFERRED EMBODIMENT FOR CARRYING OUT THE INVENTION

A dental articulator according to the concepts of the present invention is generally indicated by the numeral 10. Dental articulator 10 includes a lower base generally indicated by the numeral 12, which may also be referred to as a mandibular base 12, and an upper base generally indicated by the numeral 14, which may also be referred to as a maxillary base 14

Lower base 12 includes a support 16 on which a lower dental cast support 18 may be mounted. Support 16 includes a magnet 20 and one or more guide pins 22 for matching up with a corresponding magnet and one or more guide holes, respectively, on the lower part of lower dental cast support 18. As generally known in the art, lower dental cast support 18 may be positioned in the same location to the hinge axis of the articulator 10 as the dental patient's jaw bears to the temporomandibular (jaw) joints of the patient in the centric position of the mandible. As generally known in the art, the jaw hinge axis in the centric position of the mandible may be determined by a jaw hinge axis locater, such as a hinge bow or a face bow.

At a first end, support 16 includes a slotted opening 24 for receiving an incisal pin assembly 26, as will be further discussed herein. Near the opposed end of support 16, a support arm 28 extends upwardly from a portion of each side surface of support 16. Support arms 28 are fixedly positioned with respect to each other and support 16. Support arms 28 may be separated by any suitable distance for providing a desired intercondylar distance. The intercondylar distance of articulator 10 is a fixed distance.

Support arms 28 may utilize an ergonomic design particularly adapted to receive a user's hands. Support arms 28 may be described as a gripping portion having a curved shape 29 in the front to rear direction and a curved shape 31 in the inner to outer direction. Curved shape 29 may also be described as having a front curved surface and a rear curved surface and curved shape 31 may also be described as having an inner curved surface and an outer curved surface. Thus, support arms 28 may be said to form an S-type shape.

The rear curved surface of support arms 28 may have a plurality of curved indents 33, which may also be described as finger recesses 33. Finger recesses 33, with curved shape 29 and curved shape 31, may be particularly adapted to match the shape of a user's hand, resulting in a comfortable and secure grip for a user.

The upper end of each support arm 28 includes an opening 30 for receiving a respective temporomandibular joint (TMJ) assembly 32, 34. Particularly, a corresponding extension 36, 38 of TMJ assemblies 32, 34 fits within openings 30. The shapes of extensions 36, 38 and openings 30 should suitably correlate so as to fully secure extensions 36, 38 within openings 30. The particular shapes of extensions 36, 38 and openings 30 may be any suitable shape. In one or more embodiments, extensions 36, 38 and openings 30 may be square shaped.

Near the upper end of each support arm 28, the inner sidewall of at least one support arm 28 includes a hole 40, such as a threaded hole 40, for receiving a respective removable fastener 42, such as a threaded screw 42. In one or more embodiments, only one of support arms 28 includes a hole 40 such that a single screw may be utilized to secure maxillary base 14 in position. In other embodiments, both support arms 28 include a hole 40.

As will be further discussed herein, first TMJ assembly 32, which may also be referred to as fixed TMJ assembly 32 or fixed-angle TMJ assembly 32, is adapted to provide dental articulator 10 with a fixed horizontal condyle angle. Second TMJ assembly 34, which may also be referred to as adjustable TMJ assembly 34 or adjustable-angle TMJ assembly 34, is adapted to provide dental articulator 10 with an adjustable horizontal condyle angle. Dental articulator 10 may be first provided with fixed TMJ assembly 32 by inserting fastener 42 in hole 40. The end of fastener 42 contacts extension 36 of fixed TMJ assembly 32, which may include partial insertion into extension 36, such as threading within extension 36, to secure fixed TMJ assembly 32 in position. In one or more embodiments, a flat end surface of fastener 42 contacts a flat surface of extension 36 to secure first TMJ assembly 32 in position.

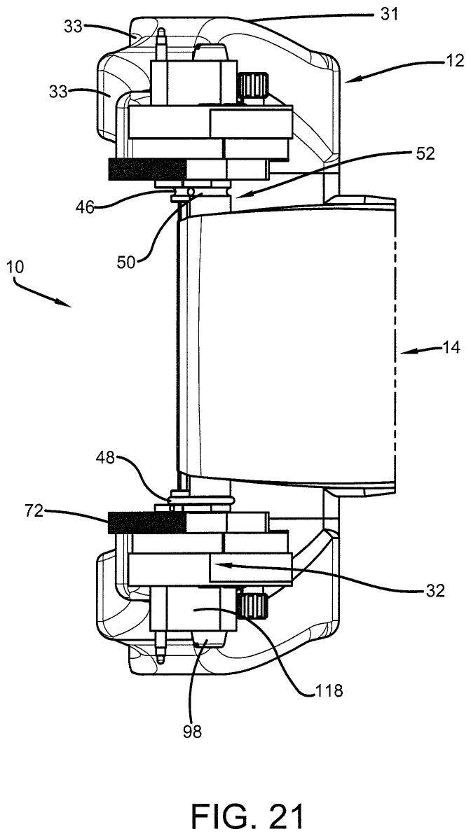

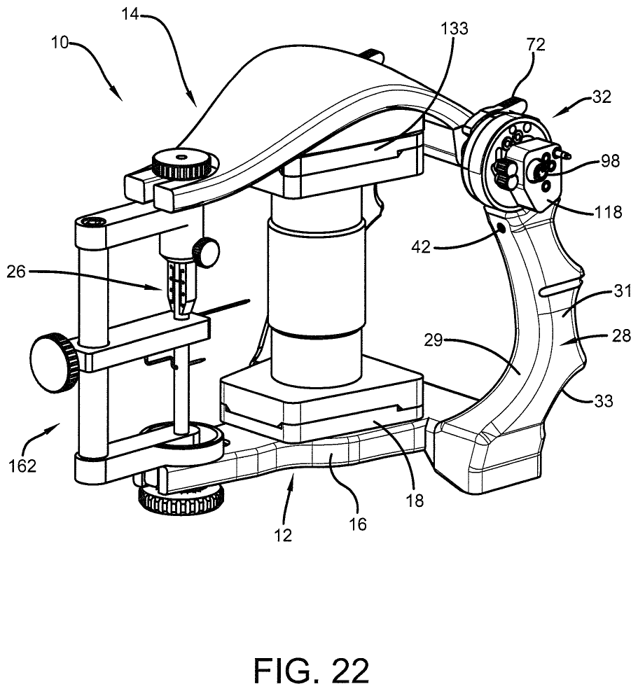

Fixed TMJ assembly 32 includes an O-ring holder 44, which may be partially threaded into fixed TMJ assembly 32. O-ring holder 44 extends from an inner surface of fixed TMJ assembly 32 and includes a groove 46 for maintaining a portion of O-ring 48 therein. As best seen in FIG. 21, a portion of O-ring 48 is also positioned within a groove 50 within an axle 52 of upper base 14. Positioning O-rings 48 in the respective grooves serves to maintain upper base 14 in a single assembly such that it may be added and removed from lower base 12 as the single assembly.

When the user desires to change from fixed TMJ assembly 32 to adjustable TMJ assembly 34, each fastener 42 is removed from contacting the respective extension 36 such that extensions 36 may be removed from openings 30. Then the O-rings 48 are removed from each of the respective grooves so that fixed TMJ assemblies 32 can be removed from coupling with axle 52. Then, O-rings 48 are repositioned in the same securing manner with each groove 50 of axle 52 and with grooves 54 in each O-ring holder 56 of adjustable TMJ assembly 34. Similarly to fixed TMJ assembly 32, each O-ring holder 56 of adjustable TMJ assembly 34 extends from an inner surface thereof. O-ring holder 56 may be partially threaded into adjustable TMJ assembly 34. Again, positioning O-rings 48 in the respective grooves serves to maintain upper base 14 in a single assembly such that it may be added and removed from lower base 12 as the single assembly. Then, adjustable TMJ assembly 34, particularly each extension 38 of adjustable TMJ assembly 34, may be placed within each opening 30. It should be appreciated that switching from adjustable TMJ assembly 34 to fixed TMJ assembly 32 may be achieved in a similar manner as described here for switching from fixed TMJ assembly 32 to adjustable TMJ assembly 34.

As described above, fixed TMJ assembly 32 includes extension 36, which downwardly extends from a TMJ guide member 62. TMJ guide member 62 includes a condylar guide channel 64 and a variety of screw holes for positioning articulator 10 to utilize articulator 10 as a model as generally known in the art. Condylar guide channel 64 receives a double cone portion 66 of axle 52, particularly a smallest diameter portion or centric diameter portion 68 of double cone portion 66, in an initial position of articulator 10.

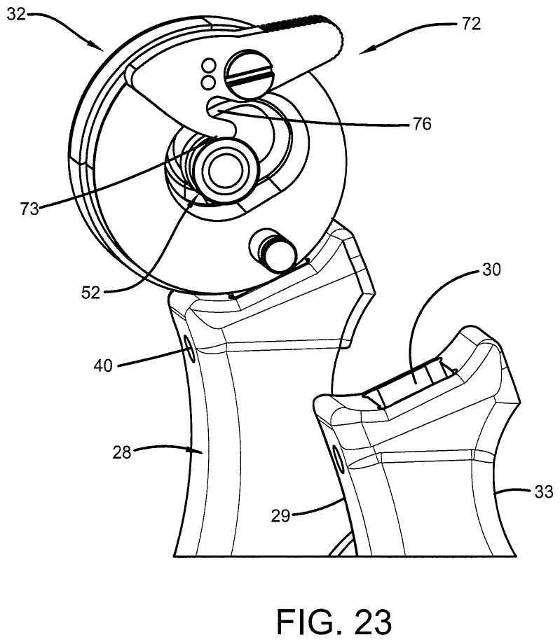

As generally known in the art, for modeling maximal intercuspidation, centric diameter 68 of the double cone 66 is placed in the deepest point 70 of guide channel 64. Double cone 66 and axle 52 can then be locked into place with respect to guide channel 64 by a TMJ centric lock 72. FIG. 23 shows TMJ centric lock 72 in a locked position with a locking surface 73 of TMJ centric lock 72 contacting axle 52. TMJ centric lock 72 may be moved backward or forward to remove locking surface 73 from contacting axle 52 to thereby move TMJ centric lock 72 to an unlocked position. TMJ centric lock 72 may include one or more screws 74 therethrough for maintaining relative position of TMJ centric lock 72, but the one or more screws 74 do not prevent movement of TMJ centric lock 72 from the locked position to the unlocked position. A ball plunger, as generally known in the art, may be utilized between TMJ centric lock 72 and TMJ guide member 62. A groove 76 may be formed in TMJ centric lock 72 to act as a ‘clip’ or ‘spring.’

When TMJ centric lock 72 is in an unlocked position, centric diameter 68 of double cone 66 is able to go forward and backward (that is, centric-protrusion and centric-retrusion) by moving along the bottom edge 73 of guide channel 64. As generally known in the art, immediate side-shift can be simulated by moving axle 52 in a transversal manner. It should be appreciated that articulator 10 thereby allows for 3-dimensional Bennett movement. Those skilled in the art will understand articulator 10 is a non-arcon articulator and therefore will understand how certain movements should correlate to modeling.

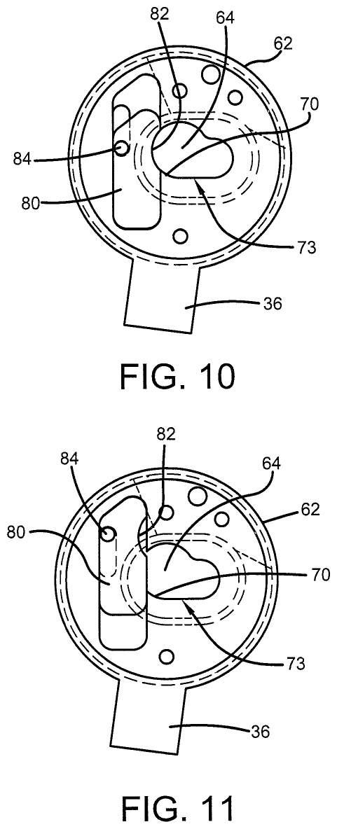

Guide channel 64 of TMJ guide member 62 further includes a retrusion lock opening 78 carrying a retrusion lock 80. Retrusion lock 80 is generally shaped to match retrusion lock opening 78 and includes an axle-receiving opening 82 and a locking screw hole 84 for receiving a locking screw 86. Retrusion lock 80 is movable within retrusion lock opening 78 between an open position (FIG. 10), where axle-receiving opening 82 is capable of receiving axle 52, and a closed position (FIG. 11), where axle-receiving opening 82 is blocked from receiving axle 52. To move retrusion lock 80 between the open and closed position, locking screw 86 is loosened to allow retrusion lock 80 to travel. When at the desired position, locking screw 86 is tightened in channel 88 to secure retrusion lock 80 in position.

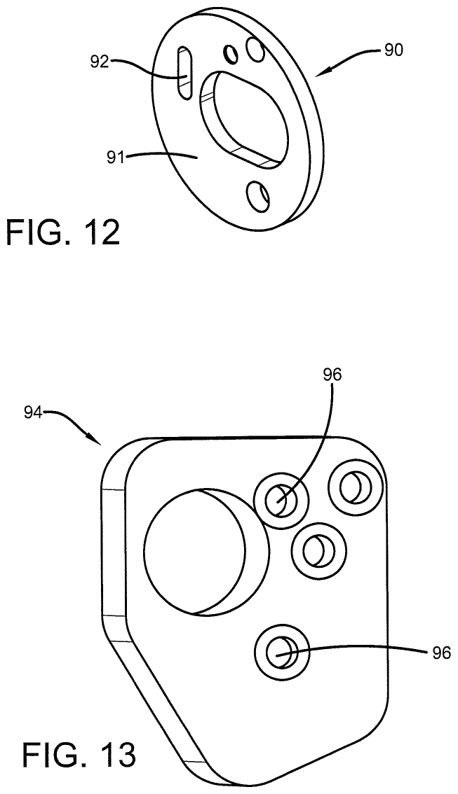

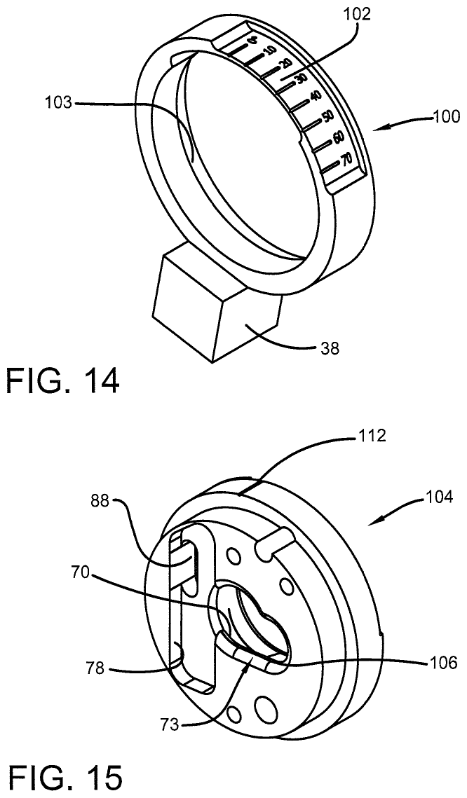

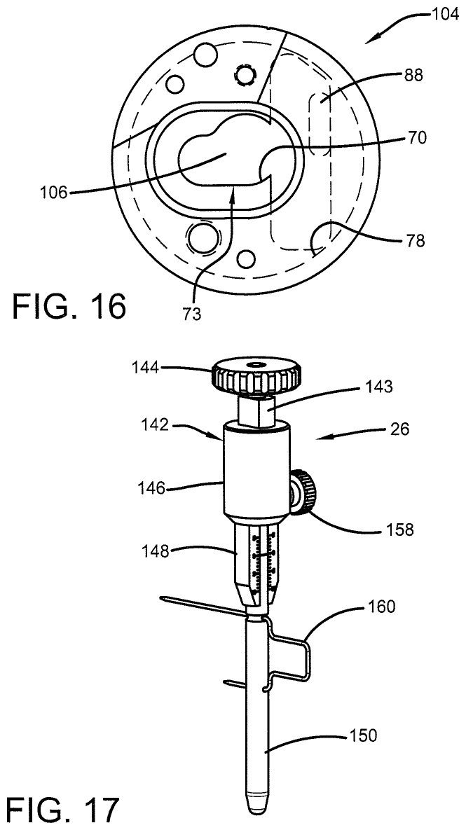

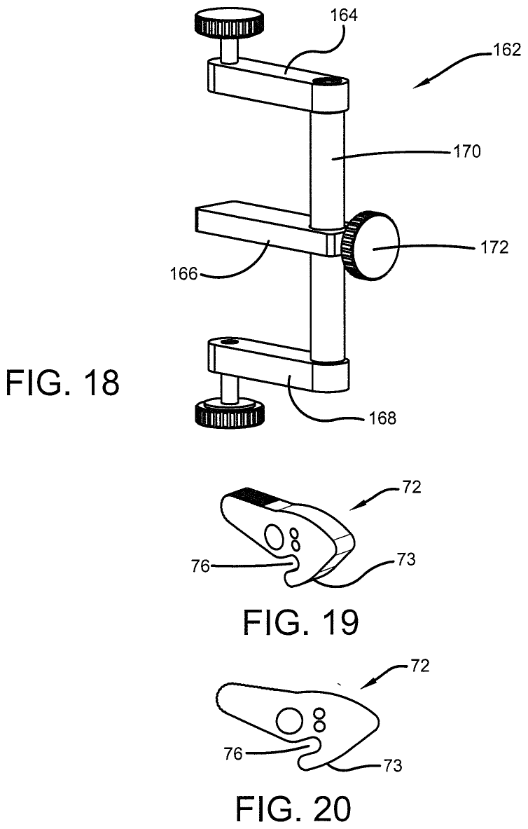

Fixed TMJ assembly 32 may further include a TMJ ring 90 (FIG. 12), which includes a channel 92 for moving retrusion lock 80 in accordance with the above description. TMJ ring 90 may be provided to provide a flat surface 91 such that a face bow adapter 94 (FIG. 13) can be suitably secured on the outside of TMJ ring 90. As generally known to the skilled person, a face bow may be utilized to record face and jaw measurements. The face bow can then transfer these recordings to articulator 10 by way of a face bow transfer. Face bow adapter 94 may include a plurality of face bow transfer openings or holes 96 for receiving different makes and models of face bows. Face bow adapter 94 may be secured to axle 52 by way of a pin and screw 98. The pin may contact the outer portion of axle 52.

Based on the fixed position of TMJ guide member 62 with respect to lower base 12, fixed TMJ assembly 32 is adapted to provide dental articulator 10 with a fixed horizontal condyle angle. The fixed horizontal condyle angle may be any suitable angle. In one or more embodiments, the fixed horizontal condyle angle may be 30°.

Adjustable TMJ assembly 34 has a similar overall structure as fixed TMJ assembly 32, although adjustable TMJ assembly 34 provides dental articulator 10 with an adjustable horizontal condyle angle. As described above, adjustable TMJ assembly 34 includes extension 38, which downwardly extends from a TMJ base member 100. As shown in FIG. 6, TMJ base member 100 includes a label 102 for reading the present horizontal condyle angle. TMJ base member 100 has an opening 103 mated with an adjustable TMJ guide member 104. TMJ guide member 104 includes a condylar guide channel 106 and a variety of screw holes for positioning articulator 10 to utilize articulator 10 as a model as generally known in the art.

When adjustable TMJ assembly 34 is utilized with articulator 10, TMJ guide member 104 is partially rotatable in relation to TMJ base member 100. This partial rotation enables the adjustable TMJ assembly 34 to provide articulator 10 with an adjustable horizontal condyle angle. A locking screw (not shown) can be positioned through TMJ base member 100 such that the locking screw can contact TMJ guide member 104 for securing the locking screw in position. The locking screw can be in a loosened or unlocked position in order to rotate TMJ guide member 104. When the desired horizontal condyle angle is reached, the locking screw is placed in a tightened or locked position to secure TMJ guide member 104 in place. TMJ guide member 104 may include an indicator line 112 corresponding with label 102 for indicating to a user the horizontal condyle angle. Based on the adjustable position of TMJ guide member 104 with respect to lower base 12, adjustable TMJ assembly 34 is adapted to provide dental articulator 10 with an adjustable horizontal condyle angle. The adjustable horizontal condyle angle range may be any suitable range. In one or more embodiments, the adjustable horizontal condyle angle range may be a range of from 0° or more to 70° or less.

It should be appreciated that other than as described above, TMJ guide member 104 is similar to TMJ guide member 62 and thus allows articulator 10 to operate in a similar manner. For example, similar numbering is utilized to refer to the components of guide channel 106 (e.g. FIG. 15) as is used for guide channel 64. Adjustable TMJ assembly 34 further includes a TMJ centric lock 114, retrusion lock 80, face bow adapter 118, and TMJ ring 120, which are similar in structure and operation to the above described respective components for the fixed TMJ assembly 32.

Though different numbers are utilized for certain components of fixed TMJ assembly 32 and adjustable TMJ assembly 34 (e.g. TMJ centric lock 72 and TMJ centric lock 114), it should be appreciated that in one or more embodiments, these certain components are similar among TMJ assembly 32 and adjustable TMJ assembly 34 and may be removed from fixed TMJ assembly 32 and provided to adjustable TMJ assembly 34, and vice versa, when changing between fixed TMJ assembly 32 and adjustable TMJ assembly 34. However, each of fixed TMJ assembly 32 and adjustable TMJ assembly 34 may be provided with their own of these comparable components for potentially quicker and more efficient changing between fixed TMJ assembly 32 and adjustable TMJ assembly 34.

As disclosed above, the in-use component of fixed TMJ assembly 32 and adjustable TMJ assembly 34 is coupled with axle 52 for moving a support 122 of maxillary base 14. Axle 52 can include an axle base 124 at least partially positioned through a channel 126, which may also be described as a hole, within a first end of support 122. Axle base 124 includes grooves 50 for positioning O-rings, as described above. For ease of manufacture, axle base may include a smaller diameter portion at each end for carrying a respective spacer 130 and double cone 66. An axle cover 132 may be provided at each end of axle 52 to secure the components of axle 52 in place. The outer surface of axle cover 132 may be cutaway for receiving the pin for securing the face bow adapters.

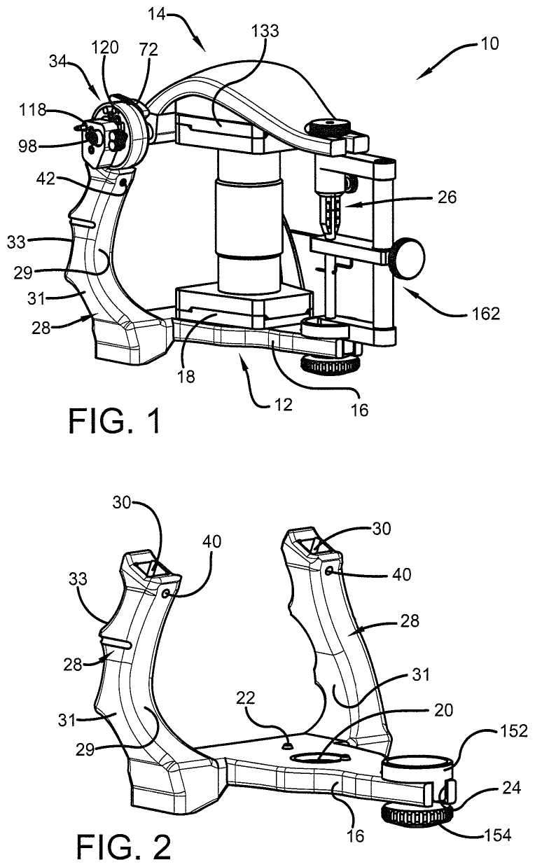

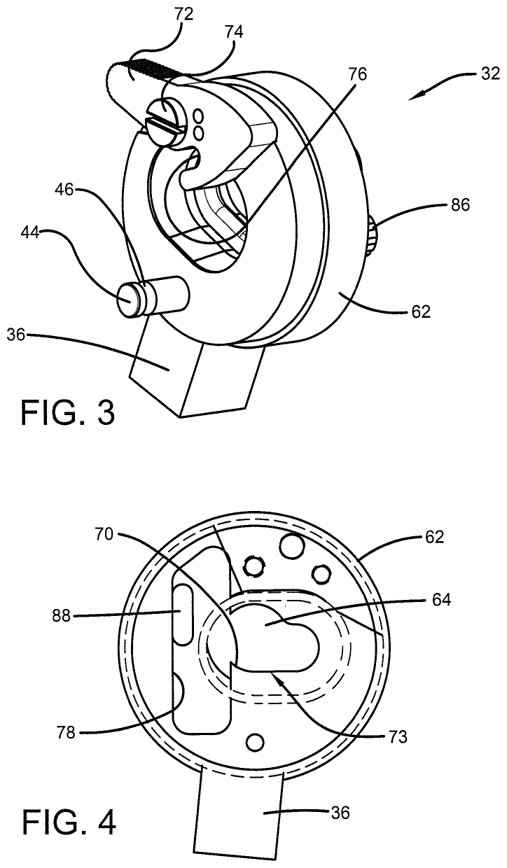

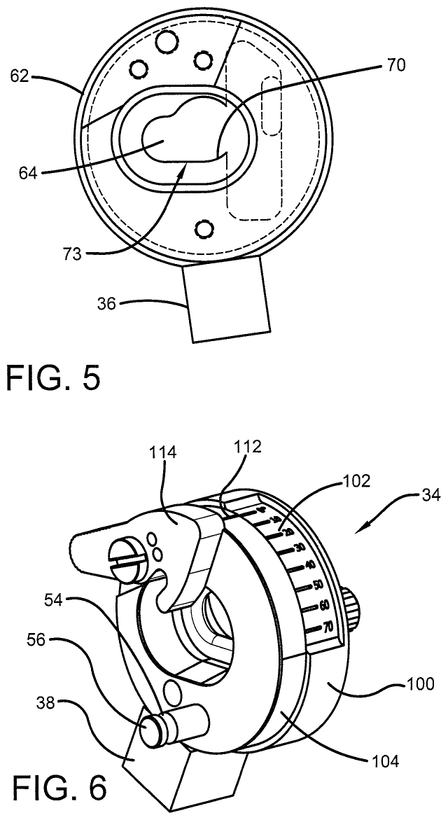

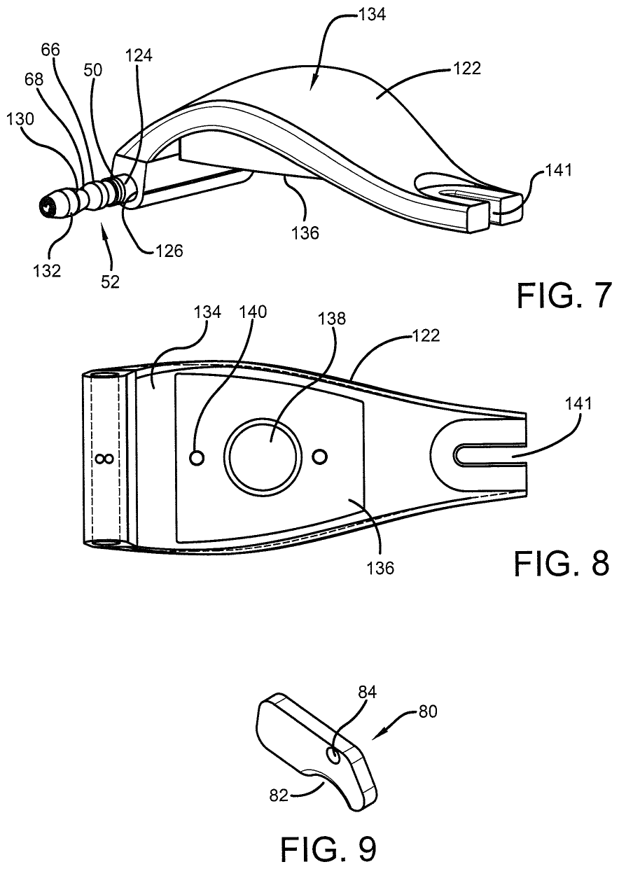

Axle 52 is fixedly secured with respect to support 122 such that support 122 can open and close with axle 52 as a hinge axis (FIG. 1 shows a closed position of support 122). This fixed securement may be provided by a small pin or any other suitable technique. Support 122 forms a component of upper base 14 on which an upper dental cast support 133 may be mounted. Support 122 may include an upper curved component 134 with a flat-surface component 136 in the concave portion of upper curved component 134.

Flat-surface component 136, which has a flat surface facing lower base 12, includes a magnet 138 and one or more guide pins 140 for matching up with a corresponding magnet and one or more guide holes, respectively, on the upper part of upper dental cast support 133. As generally known in the art, upper dental cast support 133 may be positioned in the same location to the hinge axis of the articulator 10 as the dental patient's jaw bears to the temporomandibular (jaw) joints of the patient in the centric position of the mandible.

At the end of support 122 opposite channel 126, a slotted opening 141 is provided for receiving incisal pin assembly 26. Specifically, slotted opening 141 receives an upper part 143 of an incisal pin base 142. The upper part 143 may include a threaded opening for receiving a screw 144 to secure incisal pin assembly 26 in place. Incisal pin base 142 further includes a hollow wider diameter portion 146 and a gauge portion 148 for assisting a user with setting the height. Hollow wider diameter portion 146 receives an end and further portion of an incisal pin 150 with the other end of incisal pin 150 positioned at an incisal plate 152. Incisal plate 152 may be secured in place with a screw 154 through slotted opening 24. Incisal plate 152 may have a concave upper surface, which in one or more embodiments, may be at an angle of 20°.

Incisal pin 150 is adjustable vertically by travelling through hollow wider diameter portion 146 and gauge portion 148. Hollow wider diameter portion 146 includes a locking hole for receiving a screw 158 for locking the position of pin 150. With screw 158 loosened, pin 150 can be adjusted vertically. When in the desired position, screw 158 is tightened in an opening within hollow wider diameter portion 146 to secure pin 150 in position. Pin 150 may include holes for receiving an incisal indicator wire 160. The shape and utilization of incisal indicator wire 160 are generally known to those skilled in the art.

A face bow support 162 may be utilized with incisal pin assembly 26. Face bow support 162 includes an upper horizontal support 164 positioned with the hollow wider diameter portion 146, a middle horizontal support 166 with pin 150 positioned therethrough, and a lower horizontal support 168 with the tip of pin 150 positioned therein. A vertical support 170 connects upper horizontal support 164, middle horizontal support 166, and lower horizontal support 168. A screw 172 with middle horizontal support 166 may be used for adjustment of face bow support 162. The operation of face bow support 162 is generally known in the art.

It should be appreciated that certain of the components are represented in the figures as either a left component or a right component and that the respective component for the other of the pair of TMJ assemblies will be a mirror image of the represented component.

One or more embodiments include an articulator kit having the articulator 10 described herein, where the kit provided to a user includes the articulator 10 with just the pair of fixed TMJ assemblies (e.g. fixed TMJ assembly 32). That is, these embodiments may include an articulator kit without the pair of adjustable TMJ assemblies (e.g. adjustable TMJ assembly 34). Thus, the user may first acquire the kit including the articulator 10 with just the pair of fixed TMJ assemblies, and use the articulator 10 with just the pair of fixed TMJ assemblies. At a later time, the user can then ‘upgrade’ the articulator 10 by acquiring the pair of adjustable TMJ assemblies such that the user's kit will now include both the pair of fixed TMJ assemblies and the pair of adjustable TMJ assemblies. The later time may be any suitable length of time, for example, at least one week, at least one month, or at least one year. These embodiments may provide the advantage of allowing the user to spend a lower initial cost to acquire the kit including the articulator 10 with just the pair of fixed TMJ assemblies (that is, lower compared to a kit including both the pair of fixed TMJ assemblies and the pair of adjustable TMJ assemblies), and then spend an additional cost at the later time to acquire the pair of adjustable TMJ assemblies rather than acquiring another brand-new articulator kit.

One or more embodiments include an articulator kit having the articulator 10 described herein, where the kit provided to a user includes the articulator 10 with both a pair of fixed TMJ assemblies (e.g. fixed TMJ assembly 32) and a pair of adjustable TMJ assemblies (e.g. adjustable TMJ assembly 34).

In certain embodiments, the kits described above are provided without face bow adapter 94. In these embodiments, face bow adapter 94 may be acquired by the user separately from the kit.

One or more embodiments of the present invention possess industrial applicability as providing the ability to carry out protrusive movements, laterotrusive movements, and mediotrusive movements to model the human jaw bone joint.

It is thus evident that a dental articulator constructed as described herein accomplishes the objects of the present invention and otherwise substantially improves the art.

What is claimed is:

1. A dental articulator comprising a lower base having two support arms extending therefrom, each support arm having an upper end with an opening therein, each opening being adapted to receive a fixed-angle temporomandibular joint assembly having a fixed horizontal condyle angle or an adjustable-angle temporomandibular joint assembly having an adjustable horizontal condyle angle.

2. The dental articulator of claim 1, a first of the two support arms extending upwardly from a portion of a first side surface of the lower base, a second of the two support arms extending upwardly from a portion of a second side surface of the lower base, wherein the two support arms are fixedly positioned with respect to each other.

3. The dental articulator of claim 2, wherein each of the support arms have a shape that is curved in a front-to-rear curve and an inner-to-outer curve, each of the support arms including an outer curved surface having a plurality of finger recesses formed therein.

4. The dental articulator of claim 1, wherein the fixed-angle temporomandibular joint assemblies and the adjustable-angle temporomandibular joint assemblies each have an extension adapted to fit within a respective of the openings, at least one of the support arms having an inner sidewall with a hole therein for receiving a removable fastener, wherein when the removable fastener is positioned in the hole, an end of the removable fastener contacts the extension when positioned within the respective of the openings.

5. The dental articulator of claim 4, wherein one of either the fixed-angle temporomandibular joint assemblies or the adjustable-angle temporomandibular joint assemblies are selected as an in-use pair of temporomandibular joint assemblies, the in-use pair of temporomandibular joint assemblies forming a part of an upper base, wherein only one of the support arms includes a hole such that a single removable fastener may be utilized to secure upper base in position.

6. The dental articulator of claim 4, wherein both support arms include a hole for each receiving a respective removable fastener.

7. The dental articulator of claim 1, wherein the fixed-angle temporomandibular joint assemblies and the adjustable-angle temporomandibular joint assemblies each have an extension adapted to fit within a respective of the openings, wherein one of either the fixed-angle temporomandibular joint assemblies or the adjustable-angle temporomandibular joint assemblies are selected as an in-use pair of temporomandibular joint assemblies, the in-use pair of temporomandibular joint assemblies forming a part of an upper base.

8. The dental articulator of claim 7, wherein the upper base includes a support, a channel through a first end of the support, an axle being positioned through the channel, each end of the axle being coupled with a respective one of the in-use pair of temporomandibular joint assemblies.

9. The dental articulator of claim 8, the axle including a groove positioned proximate each of the in-use pair of temporomandibular joint assemblies, each of the in-use pair of temporomandibular joint assemblies having an O-ring holder extending therefrom, the O-ring holders each having a groove for receiving an O-ring.

10. The dental articulator of claim 9, wherein when the dental articulator is in use, a first O-ring is positioned in a first of the grooves of the axle and in the groove of a first of the O-ring holders and a second O-ring is positioned in a second of the grooves of the axle and in the groove of a second of the O-ring holders, to thereby secure the axle with the in-use pair of temporomandibular joint assemblies.

11. The dental articulator of claim 10, wherein when it is desired to change the in-use pair of temporomandibular joint assemblies between the fixed-angle temporomandibular joint assemblies and the pair of adjustable-angle temporomandibular joint assemblies, the O-rings are removed from the respective grooves, and the in-use pair of temporomandibular joint assemblies are uncoupled from the axle.

12. A dental articulator kit comprising a dental articulator base having a lower support carrying two support arms extending therefrom, each support arm having an upper end with an opening therein, a pair of fixed-angle temporomandibular joint assemblies having a fixed horizontal condyle angle, the fixed-angle temporomandibular joint assemblies each having an extension adapted to fit in a respective one of the openings, and an optional pair of adjustable-angle temporomandibular joint assemblies having an adjustable horizontal condyle angle, the adjustable-angle temporomandibular joint assemblies each having an extension adapted to fit in a respective one of the openings, wherein the optional pair of adjustable-angle temporomandibular joint assemblies may be acquired by a user at a later time such that a user can upgrade the dental articulator kit to include both the pair of fixed temporomandibular joint assemblies and the pair of adjustable temporomandibular joint assemblies, wherein, upon acquiring the pair of adjustable temporomandibular joint assemblies, the pair of fixed-angle temporomandibular joint assemblies and the pair of adjustable-angle temporomandibular joint assemblies are interchangeable in the openings based on whether a user of the dental articulator kit desires a fixed horizontal condyle angle or an adjustable horizontal condyle angle.

13. A method of adjusting a dental articulator, comprising steps of
providing a dental articulator having a lower base with two support arms extending therefrom, each support arm having an upper end with an opening therein,
inserting a pair of temporomandibular joint assemblies having a fixed horizontal condyle angle in the openings,
removing the pair of temporomandibular joint assemblies having a fixed horizontal condyle angle from the openings, and
inserting a pair of temporomandibular joint assemblies having an adjustable horizontal condyle angle in the openings.

14. The method of claim 13, further comprising steps of
removing the pair of temporomandibular joint assemblies having an adjustable horizontal condyle angle from the openings, and
inserting the pair of temporomandibular joint assemblies having a fixed horizontal condyle angle in the openings.

15. The method of claim 13, wherein the dental articulator further includes an upper base having an axle, the axle having a pair of grooves, each of the pair of temporomandibular joint assemblies having a fixed horizontal condyle angle and each of the pair of temporomandibular joint assemblies having an adjustable horizontal condyle angle have an O-ring holder with a groove therein for receiving an O-ring, further comprising steps of
providing a first O-ring in a first groove of the pair of axle grooves and in the groove of the O-ring holder of a first of the pair of temporomandibular joint assemblies having a fixed horizontal condyle angle, and
providing a second O-ring in a second groove of the pair of axle grooves and in the groove of the O-ring holder of a second of the pair of temporomandibular joint assemblies having a fixed horizontal condyle angle.

16. The method of claim 15, further comprising steps of
removing the first O-ring,
removing the second O-ring,
providing the first O-ring in the first groove of the pair of axle grooves and in the groove of the O-ring holder of a first of the pair of temporomandibular joint assemblies having an adjustable horizontal condyle angle, and
providing the second O-ring in the second groove of the pair of axle grooves and in the groove of the O-ring holder of a second of the pair of temporomandibular joint assemblies having an adjustable horizontal condyle angle.

17. The method of claim 13, wherein the step of providing includes providing the dental articulator as part of a kit that includes the lower base and the pair of temporomandibular joint assemblies having a fixed horizontal condyle angle, where the kit does not initially include the pair of temporomandibular joint assemblies having an adjustable horizontal condyle angle, the method further comprising a step of acquiring the pair of temporomandibular joint assemblies having an adjustable horizontal condyle angle after the step of providing the dental articulator.
